(19) United States
(12) Patent Application Publication
(10) Pub. No.: US 2019/0105682 A1
(43) Pub. Date: Apr. 11, 2019

(54) ROLLER COVER CORE AND METHOD OF MANUFACTURE

(71) Applicant: Nova Wildcat Shur-Line, LLC, St. Francis, WI (US)

(72) Inventors: Lawrence J. Bower, Milwaukee, WI (US); Stephen R. Geissler, Brookfield, WI (US)

(21) Appl. No.: 16/152,110

(22) Filed: Oct. 4, 2018

Related U.S. Application Data
(60) Provisional application No. 62/568,473, filed on Oct. 5, 2017.

(51) Int. Cl. B05C 1/02; B29C 65/48; B29C 53/58; B29C 53/66; B29C 65/00

(52) U.S. Cl. CPC B05C 1/025; B29C 65/48; B29C 53/581; B29K 2023/12; B29C 66/4322; B29C 66/71; B29C 53/66

(57) ABSTRACT

A method of making a paint roller cover includes feeding a single strip of polypropylene, by a core material strip feeder, onto a mandrel; heating the single strip of polypropylene, by a heater, before the single strip of polypropylene is wound about the mandrel; and overlapping edges of the single strip of polypropylene as the single strip of polypropylene is wound about the mandrel so that the overlapped edges fuse together. The method also includes applying an adhesive, by an adhesive applicator, to an outer surface of the single strip of polypropylene; and feeding a strip of fabric cover material, by a fabric cover strip feeder, about the mandrel and onto the outer surface of the single strip of polypropylene.

### CROSS-REFERENCE TO RELATED APPLICATIONS

This application claims priority to U.S. Provisional Patent Application No. 62/568,473, filed Oct. 5, 2017, the entire contents of which are incorporated by reference herein.

### BACKGROUND

The present invention relates to paint rollers and, more particularly, to roller cover cores and methods of manufacturing roller cover cores.

Paint roller covers typically include a core and an outer fabric adhered to the core. The core can be made of a polypropylene strip helically wound about a mandrel. These paint roller covers, however, have been found to sometimes fail at the helically wound core seam by separation of the outer fabric. For example, one particular failure involves unraveling of a one-ply core at an outer corner of the paint roller cover, which may not be fully adhered to the outer fabric and is more susceptible to be engaged, lifted, and stressed during use, assembly, disassembly, and cleaning. Excessive and/or continued squeezing of the roller cover tends to stress this corner, potentially initiating an unravelling event.

### SUMMARY

In one embodiment, the invention provides a method of making a paint roller cover. The method includes feeding a single strip of polypropylene, by a core material strip feeder, onto a mandrel; heating the single strip of polypropylene, by a heater, before the single strip of polypropylene is wound about the mandrel; and overlapping edges of the single strip of polypropylene as the single strip of polypropylene is wound about the mandrel so that the overlapped edges fuse together. The method also includes applying an adhesive, by an adhesive applicator, to an outer surface of the single strip of polypropylene; and feeding a strip of fabric cover material, by a fabric cover strip feeder, about the mandrel and onto the outer surface of the single strip of polypropylene.

In another embodiment, the invention provides an apparatus for making a paint roller cover. The apparatus includes a mandrel and a core material strip feeder operable to feed a single strip of polypropylene onto the mandrel. Edges of the single strip of polypropylene overlap as the single strip of polypropylene is wound about the mandrel. The apparatus also includes a heater positioned adjacent the mandrel to heat the single strip of polypropylene before the single strip of polypropylene is wound about the mandrel so that the overlapped edges fuse together, an adhesive applicator operable to apply an adhesive to an outer surface of the single strip of polypropylene, and a fabric cover strip feeder operable to feed a strip of fabric cover material about the mandrel and onto the outer surface of the single strip of polypropylene.

In another embodiment, the invention provides a roller cover for use with a paint roller. The roller cover includes a core having a helically wound single strip of polypropylene including an outer surface and overlapped edges. The roller cover also includes a helically wound outer fabric layer including a backer and a fabric pile coupled to the backer. The outer fabric layer is helically wound around the core. The roller cover further includes an adhesive layer positioned between the outer surface of the strip of polypropylene and the backer of the fabric layer that couples the outer fabric layer to the core.

Other aspects of the invention will become apparent by consideration of the detailed description and accompanying drawings.

### BRIEF DESCRIPTION OF THE DRAWINGS

FIG. 1 is a partial cross-sectional view of a conventional roller cover.

FIG. 2 is a partial cross-sectional view of a roller cover according to one embodiment of the invention.

FIG. 3 is a schematic of an apparatus for making the roller cover shown in FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

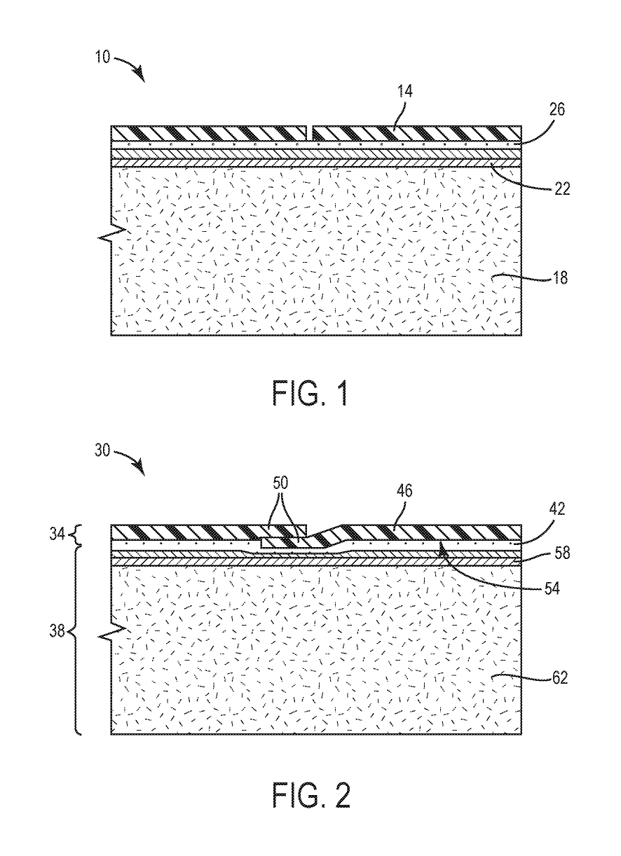

FIG. 1 illustrates a conventional paint roller cover 10. The roller cover 10 includes a core 14 and an outer fabric layer 18. The core 14 is formed from a polypropylene strip that is wound such that edges abut one another either in contact or with a slight clearance to one another. The outer fabric layer 18 includes a backer 22 that is secured to the core 14 by an adhesive 26 (e.g., a thermoplastic adhesive) or other suitable means. In this embodiment, the strength of the core 14 comes from adhesion to and strength of the outer fabric layer 18 with the backer 22.

FIG. 2 illustrates a paint roller cover 30 with improved core strength compared to the roller cover 10 shown in FIG. 1. The roller cover 30 includes a core 34, an outer fabric layer 38, and an adhesive layer 42 positioned between the core 34 and the outer fabric layer 38. In the illustrated embodiment, the core 34 is formed from a single polypropylene strip 46 that is helically wound. The strip 46 may have a thickness of, for example, between 0.018 inches and 0.035 inches. In other embodiments, the strip 46 may have other thicknesses. For example, the strip 46 may have a thickness that is less than 0.018 inches. Alternatively, the strip 46 may have a thickness that is greater than 0.035 inches. The illustrated strip 46 is helically wound so that edges 50 of the strip 46 overlap, rather than abut one another. In some embodiments, the amount of overlap may be about 0.25 inches. In other embodiments, the amount of overlap may be less than 0.25 inches. For example, the amount of overlap may be 0.2 inches, may be 0.175 inches, may be 0.15 inches, or may be 0.125 inches. In further embodiments, the amount of overlap may be less than 0.125 inches. Alternatively, the amount of overlap may be greater than 0.25 inches. In the illustrated embodiment, the edges 50 of the strip 46 are fused together by heating the strip 46 and allowing the strip 46 to cool while in contact with each other. In other embodiments, the edges 50 may be secured together with an adhesive or other suitable coupling means.

The adhesive layer 42 is applied to an outer surface 54 of the single polypropylene strip 46. The adhesive layer 42 may be, for example, a thermoplastic adhesive that is applied to the outer surface 54 in liquid form. In other embodiments, other suitable adhesives may also or alternatively be used. In some embodiments, the adhesive layer 42 may be applied over the outer surface 54 of the core 34 to even out differences in the thickness of the core 34 caused by overlapping the edges 50 of the single strip 46.

The outer fabric layer 38 includes a backer 58 and a fabric pile 62 coupled to the backer 58. The backer 58 is formed of a suitable material that is compatible to be bonded to the core 34 by the adhesive layer 42. The fabric pile 62 forms the outermost surface of the paint roller cover 30. The fabric pile 62 may include any suitable fabric or combinations of fabrics for applying paint to a surface, such as a wall or ceiling.

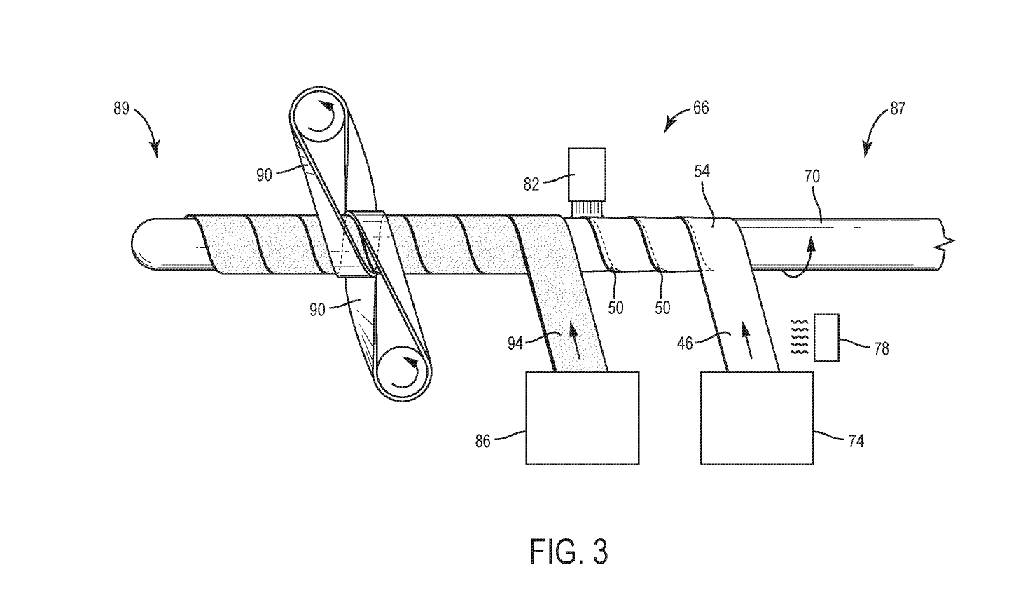

FIG. 3 illustrates an apparatus 66 for making the paint roller cover 30 shown in FIG. 2. The apparatus 66 includes a mandrel 70, a core strip material feeder 74, a heater 78, an adhesive applicator 82, and a fabric cover strip feeder 86. The mandrel 70 is a generally cylindrical member about which the roller cover 30 is formed. The mandrel 70 includes an upstream end 87 and a downstream end 89 opposite the upstream end 87. In the illustrated embodiment, the mandrel 70 is a stationary mandrel. As such, the apparatus 66 also includes drive belts 90 that engage the roller cover 30 to drive the strips of material forming the roller cover 30 axially along the mandrel 70. The drive belts 90 may be located at any suitable location along the mandrel 70. In other embodiments, other suitable drive means may be used to move the strips of material forming the roller cover 30 along the mandrel 70.

The core material strip feeder 74 is operable to feed the strip of polypropylene 46 onto the mandrel 70. In the illustrated embodiment, the core material strip feeder 74 feeds only a single strip of polypropylene onto the mandrel 70. The core material strip feeder 74 is configured to feed the strip 46 onto the mandrel 70 so the edges 50 of the strip 46 overlap as the strip 46 is wound about the mandrel 70. As discussed above, the edges 50 of the strip 74 may overlap 0.25 inches or less.

The heater 78 is positioned between the core material strip feeder 74 and the mandrel 70 to heat the strip of polypropylene 46 before the strip 46 is wound about the mandrel 70. The heater 78 may include, for example, a gas ribbon burner or flame heater. The heater 78 softens the strip of polypropylene 46 so the overlapped edges 50 of the strip 46 fuse together as the strip 46 cools. In some embodiments, a cooling circuit (e.g., water, refrigerant, or the like) may run through the mandrel 70 to help cool the strip of polypropylene 46 after the strip 46 is wound onto the mandrel 70. In other embodiments, the heater 78 may be other types of devices to make the strip 46 tacky. For example, the heater 78 may include an ultra-sonic welder that uses friction to heat the strip 46.

The adhesive applicator 82 is positioned adjacent the mandrel 70 to apply an adhesive to the outer surface 54 of the strip of polypropylene 46 after the strip 46 is wound onto the mandrel 70. In the illustrated embodiment, the adhesive applicator 82 applies a liquid adhesive to the outer surface 54. More particularly, the adhesive applicator 82 applies liquid polypropylene to the strip 46. In other embodiments, the adhesive applicator 82 may apply other suitable adhesives to the strip 46.

The fabric cover strip feeder 86 is operable to feed a strip of fabric cover material 94 that forms the outer fabric layer 38 about the mandrel 70 and onto the outer surface 54 of the strip of polypropylene 46. The strip of fabric cover material 94 is wound around the strip of polypropylene 46 in the same orientation as the strip of polypropylene 46 is wound about the mandrel 70. In other words, the strip of fabric material 94 mirrors the strip of polypropylene 46 along the mandrel 70. In the illustrated embodiment, the strip of fabric cover material 94 is offset from the strip of polypropylene 46 such that the overlapped edges 50 of the strip of polypropylene 46 are generally covered by a central portion of the strip of fabric cover material 94. The strip of fabric cover material 94 wraps around the adhesive on the outer surface 54 of the strip of polypropylene 46 to secure the outer fabric layer 38 to the core 34 (FIG. 2). In other embodiments, the strip of fabric cover material 94 may be fused to the strip of polypropylene 46 with heat or a combination of heat and adhesive. For example, since the strip of polypropylene 46 is heated to overlap and fuse the edges 50, the strip 46 may still be tacky. In such embodiments, the strip of fabric cover material 94 may fuse directly to the heated strip of polypropylene 46 or less adhesive may be used to secure the strip of fabric cover material 94 to the strip of polypropylene 46, reducing material costs.

As shown in FIG. 3, the drive belts 90 engage the roller cover 30 after the strip of fabric cover material 94 is applied. In other embodiments, the drive belts 90 may engage the strip of polypropylene 46 before the adhesive and the strip of fabric cover material 94 are applied.

In some embodiments, the apparatus 66 may include a compression mechanism to help flatten the overlapped edges 50 of the strip of polypropylene 46. The compression mechanism may include, for example, a roller or cam that constantly or selectively engages the roller cover 30 to press the overlapped edges 50 toward the mandrel 70. The compression mechanism may engage the overlapped edges 50 of the strip of polypropylene 46 before the adhesive is applied, or may engage the overlapped edges 50 of the strip of polypropylene 46 after the outer fabric layer 38 is wrapped around the core 34.

After the outer fabric layer 38 is secured to the core 34, a knife or other cutting mechanism separates the assembled tube into suitable lengths of paint roller covers.

The apparatus 66, thereby, produces paint roller covers 30 formed using a single strip of material for the core 34 (rather than two or more strips), reducing the cost of the paint roller covers 30. In addition, the overlapped edges 50 of the core 34 increase the strength and rigidity of the core 34, reducing the possibility of the core 34 unravelling during use.

Various features and advantages of the invention are set forth in the following claims.

What is claimed is:

1. A method of making a paint roller cover, the method comprising:
feeding a single strip of polypropylene, by a core material strip feeder, onto a mandrel;
heating the single strip of polypropylene, by a heater, before the single strip of polypropylene is wound about the mandrel;
overlapping edges of the single strip of polypropylene as the single strip of polypropylene is wound about the mandrel so that the overlapped edges fuse together;
applying an adhesive, by an adhesive applicator, to an outer surface of the single strip of polypropylene; and
feeding a strip of fabric cover material, by a fabric cover strip feeder, about the mandrel and onto the outer surface of the single strip of polypropylene.

2. The method of claim 1, wherein feeding the single strip of polypropylene includes feeding a single strip of polypropylene having a thickness between 0.018 inches and 0.035 inches.

3. The method of claim 1, wherein overlapping edges includes overlapping edges of the single strip of polypropylene a distance less than 0.25 inches.

4. The method of claim 1, wherein applying the adhesive includes applying an adhesive in liquid form.

5. The method of claim 4, wherein applying the adhesive includes applying liquid polypropylene.

6. The method of claim 1, wherein applying the adhesive includes applying the adhesive at a first position that is downstream of overlapping the edges of the single strip of polypropylene relative to the mandrel.

7. The method of claim 6, wherein feeding the strip of fabric cover material includes feeding at a second position that is downstream of applying the adhesive relative to the mandrel.

8. The method of claim 1, further comprising driving the fabric cover material and the single strip of polypropylene axially along the mandrel with a drive belt.

9. The method of claim 1, wherein feeding the strip of fabric cover material includes feeding the strip of fabric cover material onto the single strip of polypropylene such that the fabric cover material is offset from the single strip of polypropylene.

10. The method of claim 9, wherein feeding the strip of fabric cover material includes feeding the strip of fabric cover material onto the single strip of polypropylene such that a central portion of the fabric cover material covers the overlapped edges.

11. An apparatus for making a paint roller cover, the apparatus comprising:
a mandrel;
a core material strip feeder operable to feed a single strip of polypropylene onto the mandrel, wherein edges of the single strip of polypropylene overlap as the single strip of polypropylene is wound about the mandrel;
a heater positioned adjacent the mandrel to heat the single strip of polypropylene before the single strip of polypropylene is wound about the mandrel so that the overlapped edges fuse together;
an adhesive applicator operable to apply an adhesive to an outer surface of the single strip of polypropylene; and
a fabric cover strip feeder operable to feed a strip of fabric cover material about the mandrel and onto the outer surface of the single strip of polypropylene.

12. The apparatus of claim 11, wherein the mandrel is a stationary mandrel.

13. The apparatus of claim 11, wherein the adhesive applicator is operable to apply a liquid adhesive.

14. The apparatus of claim 11, further comprising a drive belt to drive the fabric cover material and the single strip of polypropylene axially along the mandrel.

15. The apparatus of claim 11, wherein the fabric cover strip feeder is positioned downstream of the core material strip feeder relative to the mandrel.

16. The apparatus of claim 15, wherein the adhesive applicator is positioned downstream of the core material strip feeder relative to the mandrel.

17. A roller cover for use with a paint roller, the roller cover comprising:
a core having a helically wound single strip of polypropylene including an outer surface and overlapped edges;
a helically wound outer fabric layer including a backer and a fabric pile coupled to the backer, the outer fabric layer helically wound around the core; and
an adhesive layer positioned between the outer surface of the strip of polypropylene and the backer of the fabric layer that couples the outer fabric layer to the core.

18. The roller cover of claim 17, wherein the outer fabric layer is offset from the single strip of polypropylene so that a central portion of the fabric layer covers the overlapped edges.

19. The roller cover of claim 18, wherein the central portion of the outer fabric layer covers the overlapped edges for substantially the entire length of the core.

20. The roller cover of claim 17, wherein the overlapped edges overlap a distance that is less than 0.25 inches.
